(19) United States
(12) Patent Application Publication
(10) Pub. No.: US 2009/0096631 A1
(43) Pub. Date: Apr. 16, 2009

(54) OPERATING DEVICE FOR OPERATING A MACHINE TOOL, PRODUCTION MACHINE AND/OR A ROBOT

(75) Inventors: JENS-ANDRE BUNK, Erlangen (DE); Sven Moniac, Erlangen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/249,284

(22) Filed: Oct. 10, 2008

(30) Foreign Application Priority Data
Oct. 11, 2007 (EP) EP 07019944

(51) Int. Cl. G08B 5/36

(52) U.S. Cl. 340/815.55; 340/815.4

(57) ABSTRACT

An operating device for operating a machine tool, production machine and/or a robot includes a transparent pane and a display arranged behind the pane. The pane has an edge region projecting beyond the display. The control device includes an indicating device which transmits an indication signal through the edge region. This arrangement simplifies the design of the operating device.

### CROSS-REFERENCES TO RELATED APPLICATIONS

This application claims the priority of European Patent Application, Serial No. EP 07019944, filed Oct. 11, 2007, pursuant to 35 U.S.C. 119(a)-(d), the content of which is incorporated herein by reference in its entirety as if fully set forth herein.

### BACKGROUND OF THE INVENTION

The present invention relates to an operating device for operating a machine tool, production machine and/or a robot.

In conventional commercial operating devices for operating machine tools, production machines and/or robots, the indication elements are either fixedly incorporated into the front of the operating device outside the pane of glass which serves to cover the conventionally used display of the operating device or inserted into the operating device from the outside in the form of installation elements or fixedly integrated into keyboard overlays.

A drawback of a conventional commercial operating device of this type is the fact that the indication elements generally protrude beyond the front surface of the operating means and, as a result of the design, their position and number cannot be arranged variably or can be so only with difficulty. The gaps which form between the front of the operating device and the indication elements allow dirt to infiltrate the operating device and in this way lead to errors in the operating device. In addition, if indication elements of electronics integrated in the operating device are to be inspected, the entire operating device generally has to be opened. Depending on the design of the operating device, this is costly and time-consuming. Thus, especially in operating devices of complex construction, access to the indication elements of the implemented electronics of the operating device is often necessary. In order to be able to carry out these required operations, the operating device as a whole has, as described hereinbefore for conventional commercial operating devices, to be disassembled or at least made accessible/opened at the site of installation. Furthermore, alternating forms of indication are relatively costly to bring about in conventional commercial operating devices, as the indication elements are implemented fixedly in the front and/or in the keyboard overlays. Furthermore, in operating devices having an overlay keyboard, it is difficult to implement in the keyboard overlay indication fields which are illuminated in a planar manner.

It would therefore be desirable and advantageous to provide an improved operating device to obviate prior art shortcomings.

### SUMMARY OF THE INVENTION

According to one aspect of the present invention, an operating device for operating a machine tool, production machine and/or a robot includes a transparent pane having an edge region, and a display arranged behind the transparent pane. The edge region of the transparent pane projects beyond the display. An indicating device operates to send an indication signal through the edge region.

According to another advantageous feature of the present invention, the indicating device may include a light source, wherein the light source is arranged behind the edge region of the pane and a light beam generated by the light source can be coupled into the edge region of the pane. The arrangement of the light source behind, in particular directly behind, the edge region of the pane provides a particularly simple overall arrangement.

According to another advantageous feature of the present invention, the indicating device may include a light source and a light guide element, wherein a light beam generated by the light source can be coupled into the edge region of the pane via the light guide element. If a light guide element is used, it is no longer necessary for the light source to be arranged behind, in particular directly behind, the edge region of the pane.

Advantageously, the indicating device may have a fixedly incorporated or exchangeable film strip with an indication symbol. At least a partial region of the film strip may be arranged between the light source and the edge region, or at least a partial region of the film strip may be arranged between the light guide element and the edge region. Indication symbols, in particular exchangeable indication symbols, can easily be provided in this way.

According to yet another advantageous feature of the present invention, the indicating device may include a movable film strip which is opaque at least in a partial region, wherein the partial region of the film strip may be arranged between the light source and the edge region or the partial region of the film strip may be arranged between the light guide element and the edge region. A film strip, in particular a film strip which is opaque and can be moved from the outside without intervening in the interior of the operating device, can be moved, for example if the operating device is defective, by removing or displacing it, thereby allowing the indicating device located behind it to be viewed. Thus, the user can carry out for example service/monitoring and/or troubleshooting operations on the operating device from the outside without intervening in the interior of the operating device.

According to another advantageous feature of the present invention, the indicating device may include an light screen element, wherein the optical transparency of the light screen element can be electrically controlled, and wherein at least a partial region of the light screen element may be arranged between the light source and the edge region or at least a partial region of the light screen element may be arranged between the light guide element and the edge region. This measure facilitates a field of vision which can be influenced electrically and is in the rest state, for example, non-transparent and becomes transparent only when an external electric voltage is applied, thus revealing the electronics, located behind it, of the operating device and the indicating devices thereof (for example a 7-segment LED, status LEDs).

According to yet another advantageous feature of the present invention, the optical transparency of the light screen element may be controlled from outside the operating device; for example, if the light screen element can be controlled from outside the operating device, then important information may be sent by an on-site operator to an external service technician via video link, after the service technician has rendered the light screen element transparent from the outside, without directly intervening in the apparatus, to allow better and/or more rapid diagnosis for troubleshooting and/or start-up.

According to another feature of the present invention, the operating device according to the invention can advantageously be embodied in a machine tool, production machine and/or a robot.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a view of an operating device according to the invention;

FIG. 2 shows various embodiments of the invention; and

FIG. 3 shows additional embodiments of the invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

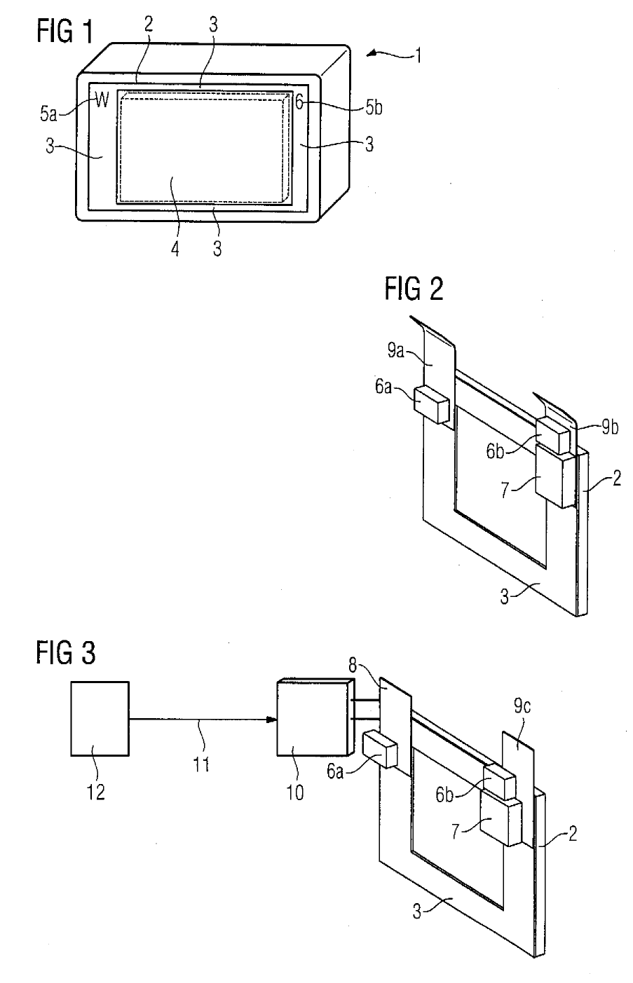

Turning now to the drawing, and in particular to FIG. 1, there is shown a schematic, perspective, front view of an operating device 1 according to the invention. The operating device 1 has a pane 2 which is transparent and, in the exemplary embodiment, is configured as a glass pane. A display 4 is arranged behind the pane 2, i.e. on the side of the pane 2 that faces the inside of the operating device 1, inside the operating device 1, the display 4 being indicated in FIG. 1 by broken lines. The front region of the display 4 is in this case smaller than the front surface of the pane 2, so that the pane 2 has an edge region 3 projecting beyond the display 4.

Furthermore, the operating device 1 has an indicating device arranged behind the pane 2 within the operating device 1, wherein an indication signal, which is, within the exemplary embodiment, in the form of a character 5a or a character 5b, can be sent by the indicating device through the edge region 3 of the pane 2. The character 5a is in this case, within the exemplary embodiment, in the form of the letter “W” and the character 5b in the form of the digit “6”.

A coloring element, which is opaque and can for example be configured in the form of a film, can in this case be attached to the surface of the edge region 3. The coloring element has in this case in the region of the indication signals 5a and 5b a, for example, square recess which is transparent.

FIG. 2 is a schematic, perspective view of the rear side, i.e. the side facing the interior of the operating device 1, of the pane 2, with two embodiments of the indicating device. In the indicating device shown on the left-hand side of FIG. 2, the indicating device has a light source 6a, the light source being arranged, within the exemplary embodiment, behind, in particular directly behind the edge region 3 of the pane 2. A light beam generated by the light source 6a is in this case coupled into the edge region 3 of the pane 2. The indicating device has in this case a film strip 9a which is exchangeable or fixedly incorporated into the operating device 1, the film strip having an indication symbol, for example in the form of a character to be represented (for example the digit “6”). The indication symbol can in this case for example be printed onto the film strip. In this case, the film strip is arranged at least in a partial region of the film strip between the light source 6a and the edge region 3, so that the indication signal is produced when the light beam penetrates the film strip 9a.

In FIG. 2, a further embodiment of the indicating device is shown on the right-hand side, the indicating device having in this case a light source 6b and a light guide element 7, for example in the form of a fiber optic, a light beam generated by the light source 6b being coupled into the edge region 3 of the pane 2 via the light guide element 7. This embodiment has the advantage over the embodiment on the left-hand side that the light source 6b does not have to be arranged behind the pane 2. In accordance with the film strip 9a, the embodiment on the right-hand side of FIG. 2 also has a film strip 9b with an indication symbol, for example in the form of a character to be represented (for example the letter “W”), at least a partial region of the film strip 9b being arranged between the light guide element 7 and the edge region 3 of the pane 2. The indication signal is generated in that a light beam generated by the light source 6b is guided by the light guide element 7 and the light beam is coupled into the pane 2 by means of the light guide element 7 and subsequently the light beam penetrates the film strip 9b with the indication symbol printed onto the film strip 9b.

In the simplest case, the light source can for example be in the form of an LED.

A broad range of indication symbols, and thus indication signals, can be provided in a simple manner for the user with the aid of the exchangeable film strips, simply by exchanging the film strips.

FIG. 3 shows further embodiments of the invention. The embodiment illustrated on the right-hand side of FIG. 3 corresponds in its basic construction substantially to the above-described embodiment on the right-hand side of FIG. 2. Like elements are therefore provided on the right-hand side of FIG. 3 with the same reference numerals as on the right-hand side of FIG. 2. The only real difference is that in the embodiment on the right-hand side of FIG. 3, the film strip 9c is configured as a movable film strip which is opaque. The normal user will thus not be able to see the indication signal, as said indication signal is covered by the film strip 9c which is opaque. In a service scenario, if for example the operating device displays a fault, a service technician can then for example withdraw the film strip 9c from the operating device and/or displace the film strip and can subsequently visually detect the indication signal. The indication signal can then for example provide the service technician with information about the fault.

The light source 6b can in this case be for example in the form of an LED, in particular a 7-segment LED, and for example be part of any desired module of the operating device that is arranged within the operating device. A fault on the module is then signaled via the LED, so that the service technician can easily and rapidly locate the fault.

A further embodiment of the invention is illustrated on the left-hand side of FIG. 3. The indicating device has in this embodiment of the invention a light source 6a and a light screen element 8, the optical transparency of the light screen element 8 being electrically controllable, at least a partial region of the light screen element 8 being arranged between the light source 6a and the edge region 3. The light screen element 8 is activated by means of an activation device 10 which generates an activation voltage for controlling the optical transparency of the light screen element 8. The light source 6a can in this case, for example also as on the right-hand side, be in the form of an LED, in particular a 7-segment LED of an indication element of a module of the operating device. The activation device 10 is in this case integrated into the operating device 1. An operating element integrated into the operating device 1 then allows the operator to switch the light screen element over, in the event of a fault, from opaque to transparent, thus revealing the indicating device located behind it and allowing the operator (for example a service technician) to infer information from the indicating device.

Alternatively or additionally, the operating device, and in particular the activation device 10, can have an interface with the aid of which it can be linked (for example via an Internet connection) to an external data device 12, which can for example be in the form of a personal computer, for the exchange of data. The optical transparency of the light screen element 8 can then be controlled, for example by a service technician, via the external device 12. If a normal user identifies an error in the operating device, it is possible to advise, for example via a hotline, a service technician who then activates the activation device 10 by means of the external device 12 (this is indicated by an arrow 11) and makes the light screen element 8 transparent, thus allowing the user to view the indicating device, which is arranged behind the light screen element 8, and thus the indication signal. Subsequently, the user can send on site, for example through a video link, important information for troubleshooting to the service technician without intervening (for example screwing onto the operating device) in the operating device. It should be noted at this point that obviously the light screen element 8 can also replace the film strip 9c in the embodiment on the right-hand side of FIG. 3.

Obviously, mixed forms and combinations between the individual illustrated exemplary embodiments are possible.

It should in this regard be noted at this point that the film strip may also be dispensed with; in this way, the light source sends the indication signal directly through the edge region of the pane. In this case, the indication signal is directly in the form of the light beam.

In addition, it should be noted at this point that the indicating device does not necessarily have to have an LED as the light source, but rather that other light sources are also possible.

Furthermore, it should be noted that the indicating device can also consist only of the light source.

The invention allows information selectively to be displayed permanently or non-permanently (for example for service scenarios) in the edge region of the pane. The invention thus simplifies the work of service technicians and/or start-up operators, who then no longer need to open and/or dismantle the entire operating device each time an error occurs, as was previously conventional. Furthermore, the invention also allows remote maintenance of the operating device.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An operating device for operating a machine tool, production machine or robot, comprising:
a transparent pane having an edge region,
a display arranged behind the transparent pane, with the edge region of the transparent pane projecting beyond the display, and
an indicating device operating to send an indication signal through the edge region.

2. The operating device of claim 1, wherein the indicating device comprises a light source arranged behind the edge region of the pane, said light source generating a light beam for coupling into the edge region.

3. The operating device of claim 2, wherein the indicating device further comprises a fixedly incorporated or exchangeable film strip with an indication symbol, with at least a partial region of the film strip being arranged between the light source and the edge region.

4. The operating device of claim 2, wherein the indicating device further comprises a movable film strip which is opaque at least in a partial region, with the partial region of the film strip being arranged between the light source and the edge region.

5. The operating device of claim 2, wherein the indicating device comprises an light screen element with an electrically controllable optical transparency, wherein at least a partial region of the light screen element is arranged between the light source and the edge region.

6. The operating device of claim 5, wherein the optical transparency of the light screen element is controllable from outside the operating device.

7. The operating device of claim 2, wherein the indicating device further comprises a light guide element coupling the light beam into the edge region.

8. The operating device of claim 7, wherein the indicating device further comprises a fixedly incorporated or exchangeable film strip with an indication symbol, with at least a partial region of the film strip being arranged between the light guide element and the edge region.

9. The operating device of claim 7, wherein the indicating device further comprises a movable film strip which is opaque at least in a partial region, with the partial region of the film strip being arranged between the light guide element and the edge region.

10. The operating device of claim 7, wherein the indicating device comprises an light screen element with an electrically controllable optical transparency, wherein at least a partial region of the light screen element is arranged between the light guide element and the edge region.

11. The operating device of claim 10, wherein the optical transparency of the light screen element is controllable from outside the operating device.

12. A machine tool, production machine or robot having an operating device comprising:
a transparent pane having an edge region,
a display arranged behind the transparent pane, with the edge region of the transparent pane projecting beyond the display, and
an indicating device operating to send an indication signal through the edge region.
